(19) United States
(12) Patent Application Publication
(10) Pub. No.: US 2019/0392322 A1
(43) Pub. Date: Dec. 26, 2019

(54) ELECTRONIC COMPONENT PACKAGING TYPE CLASSIFICATION SYSTEM USING ARTIFICIAL NEURAL NETWORK

(71) Applicant: FootPrintKu Inc., Kaohsiung City (TW)

(72) Inventors: Jiun-Huei Ho, Kaohsiung City (TW); Mong-Fong Horng, Kaohsiung City (TW); Yan-Jhih Wang, Kaohsiung City (TW); Chun-Chiang Wei, Kaohsiung City (TW); Yi-Ting Chen, Kaohsiung City (TW)

(21) Appl. No.: 16/015,335

(22) Filed: Jun. 22, 2018

(51) Int. Cl. G06N 3/08; G06N 3/04

(52) U.S. Cl. CPC G06N 3/084; G06N 3/04

(57) ABSTRACT

An electronic component packaging type classification system using artificial neural network to execute classification; the electronic component packaging system includes a service database, an external database, a feature selection module, a data-integration module and a classification processing module. The service database receives electronic component patterns externally inputted. The external database stores the packaging type data of electronic components. The feature selection module records the packaging type features of the electronic components. The data-integration module performs the data-processing and the normalization for the selected features to obtain the data to be processed. The classification processing module receives the data to be processed and shows the classification result on the service database.

### BACKGROUND OF THE INVENTION

### 1. Field of the Invention

The present invention relates to a classification system, in particular to an electronic component packaging type classification system using artificial neural network to execute classification.

### 2. Description of the Prior Art

Nowadays, the design and assembling processes of electronic circuits are gradually automated with the development of technology. In the process of designing a printed circuit board, it is necessary to import the footprint library, execute the PCB parameter setup, placement and routing before the final stage (known as a Design For Manufacture Check or DFM Check).

Before the DFM check is executed, the conventional process is that a layout engineer classifies the packaging types of all electronic components of a printed circuit board manually. To determine the packaging types of the electronic components, the layout engineer usually depends on checking the names of the electronic component patterns, as well s the pin number and the pin arrangement from the appearance. The above process should depend on the working experience of the engineer; however, the engineer cannot make sure that the packaging types of the electronic components are correctly classified.

With the advance of packaging technology, the packaging types of various electronic components are becoming more diverse; besides, some electronic component patterns of some packaging types are very similar. For the layout engineers, it is more difficult to determine the packaging type of one electronic component according to its electronic component pattern. Further, if the layout engineers fail to correctly determine the packaging types of the electronic components, the working process of the layout engineers, the yield rate and the product quality of the assembling factories will be influenced.

All of the above shortcomings show that various problems that occur during the conventional operation process for the electronic component packaging type classification. Therefore, it has become an important issue to develop a packaging type classification tool to assist the layout engineers to reduce the error rate of the electronic component packaging type classification.

### SUMMARY OF THE INVENTION

To achieve the foregoing objective, the present invention provides an electronic component packaging type classification system using an artificial neural network to perform classification, and the electronic component packaging type classification system includes a service database, an external database, a feature selection module, a data-integration module and a classification processing module.

The service database receives electronic component patterns externally inputted and receives training data with input and output data related thereto. The external database stores the packaging type data of a plurality of electronic components. The feature selection module is connected to the external database; the feature selection module records the packaging type features of the electronic components and inputs the electronic component patterns to be classified according to the service database, wherein the feature selection module performs the feature selection from the external database according to the packaging type features.

The data-integration module performs the data pre-processing and the normalization for the feature value of the feature selected by the feature selection module in order to remove incorrect noises, fill data loss and limit the feature value of the selected feature in a specific interval to obtain the data to be classified. The classification processing module receives the data to be classified and displays the classification result on the service database.

In an embodiment of the present invention, the classification processing module includes a processor for storing and executing the instruction of an operation, and the operation includes: a user end inputting the electronic component patterns to be classified into the service database; the feature selection module performing the feature selection from the external database according to the packaging type features of the electronic component patterns; the data-integration module performing the data pre-processing and the normalization for the feature value of the selected feature to obtain the data to be classified; and the service database obtaining the classification result of the packaging types of the electronic components.

In an embodiment of the present invention, the electronic component packaging type classification system further includes a training module and a parameter storage module, wherein the training module is connected to the data-integration module and the service database, and determines a training scale and the neural network parameters of a training data set for following classification, wherein the convergence condition of training is that the cumulative error is lower than a given threshold value after the current training ends. The parameter storage module is connected to the training module and the service database, and records the training parameter data used by the training module.

In an embodiment of the present invention, the data-integration module normalizes the feature value to the interval between vₐ and v_{b} to conform to

$${v}^{′} = {v}_{a} + \frac{( v - {v}_{min} ) \times ( {v}_{b} - {v}_{a} )}{{v}_{max} - {v}_{min}} , {v}_{a} < {v}_{b} ,$$

the equation, where v′ stands for the feature value after being normalized to vₐ and v_{b}, v stands for the feature value needed to be normalized, vₘₐₓ stands for the largest feature value of one feature and vₘᵢₙ is the smallest feature value of one feature.

In an embodiment of the present invention, the training module integrates the feed-forward neural network structure with the backpropagation algorithm.

In an embodiment of the present invention, the neural network parameters are any one of the convergence condition, the neuron number of the hidden layer, the number of the hidden layers, the initial learning rate, the initial momentum, the threshold value, the weight and the bias or the combination thereof.

In an embodiment of the present invention, the convergence condition of training is that the cumulative error is lower than 1/15000 of the cumulative error of the previous training after the current training ends; vₜ^{rmse} stands for the cumulative RMSE of the current training and vₜ₋₁^{rmse} stands for the cumulative RMSE of the previous training; vₜ^{rmse} and vₜ₋₁^{rmse} conform to the equation,

$$( {v}_{t}^{rmse} - {v}_{t - 1}^{rmse} ) < \frac{{v}_{t - 1}^{rmse}}{15000} ,$$

where vₜ^{rmse} and vₜ₋₁^{rmse} conform to the equation,

$${v}^{rmse} = \frac{{\sum }_{i = 0}^{{c}_{d}} \sqrt{\frac{{\sum }_{j = 0}^{{c}_{o}} {( {v}_{k}^{c} - {v}_{k ( t )}^{a} )}^{2}}{{c}_{o}}}}{{c}_{d}} ,$$

where v^{rmse} stands for the cumulative RMSE after each training result, c_{d} i stands for the data amount of the training data set, c_{d} stands for the output bit number of neural network, vₖ^{c} stands for the target value of the classification result and vₖ₍ₜ₎^{a} stands for the approximate value of the current classification result.

In an embodiment of the present invention, the training scale includes an input layer, a hidden layer and an output layer; the output layer is the feature number of the inputted packaging type, the number of the hidden layers is 1, and the output layer is 10 packaging types of classification output.

In an embodiment of the present invention, the packaging types outputted are the ball grid array (BGA), the quad flat package (QFP), the quad flat no-lead (QFN), the small outline integrated transistor (SOT), the small outline integrated circuit (SOIC), the small outline integrated circuit no-lead (SON), the dual flat no-lead (DFN), the small outline diode (SOD), the small SMC chip and the metal electrode leadless face (MELF).

In an embodiment of the present invention, the neuron number of the hidden layers conforms to the equation, (x×(input+output)) 4.5<x<2, where the input stands for 19 packaging type features and the output stands for the 10 packaging types of classification output.

In an embodiment of the present invention, the classification type data record any one of the component outline information, the limited area information of printed circuit board, the drill information, the geometrical form parameter, the applicable site parameter, the electrical parameter and the joint parameter or the combination thereof.

In an embodiment of the present invention, the packaging type features include the physical appearance of electronic component, the physical pin of electronic component and the pattern of electronic component.

In an embodiment of the present invention, the weight ratio of the packaging type features is that the pattern of electronic component is higher than the physical appearance of electronic component, and the physical appearance of electronic component is higher than the physical pin of electronic component.

In an embodiment of the present invention, the physical appearance of electronic component, the physical pin of electronic component and the pattern of electronic component are selected from the group consisting of 19 kinds of features, the number of pins from electronic component, the original physical length of electronic component, the maximal physical length of electronic component, the minimal physical length of electronic component, the original physical width of electronic component, the maximal physical width of electronic component, the minimal physical width of electronic component, the physical height of electronic component, the distance between the physical body of electronic component and circuit board, the pin length of large electronic component, the pin width of small electronic component, the pin length of large electronic component pattern, the pin length of small electronic component pattern, the pin width of large electronic component pattern, the pin width of small electronic component pattern, the X-axis direction of pin interval of electronic component pattern and the Y-axis direction of pin interval of electronic component pattern.

The technical effects of the present invention are as follows: the artificial neural network can be trained via the physical features of the electronic components so as to find out the training scale and the neural network parameters most appropriate to the classification system; besides, the correct rate of the normalized training result is higher than that of the training result not normalized, which can solve the problems that manually classifying the packaging types of the electronic components tends to result in mistakes, is time-consuming and seriously depends on the working experience of layout engineers, and can further better the quality of the training and the classification result.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 is the block diagram of the electronic component packaging type classification system using artificial neural network to perform classification of a preferred embodiment in accordance with the present invention.

FIG. 2 is the schematic view of the node output calculation stage of a preferred embodiment in accordance with the present invention.

FIG. 3 is the schematic view of executing training of a preferred embodiment in accordance with the present invention.

FIG. 4 is the schematic view of the weight correction stage of a preferred embodiment in accordance with the present invention.

FIG. 5 is the flow chart of the classification processing module executing the instruction of an operation in accordance with the present invention.

### DETAILED DESCRIPTION OF THE PREFERRED EMBODIMENT

The following description is about embodiments of the present invention; however, it is not intended to limit the scope of the present invention.

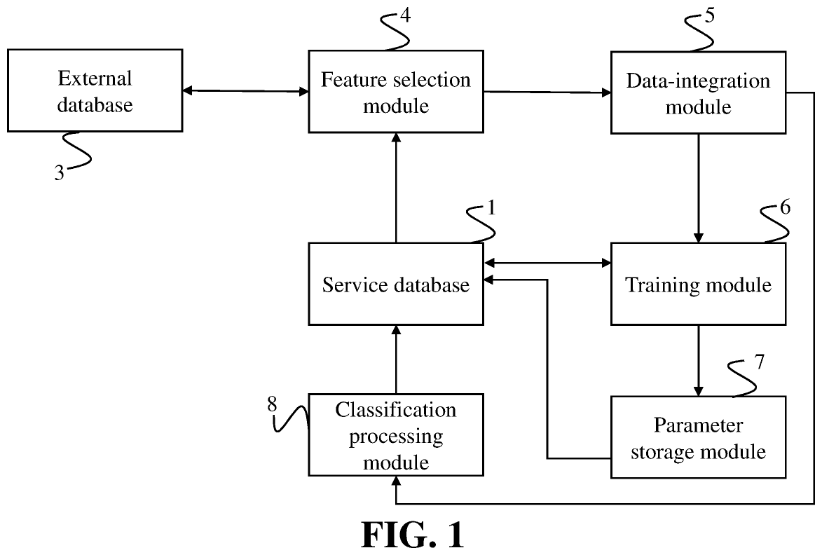

With reference to FIG. 1 for an electronic component packaging type classification system using artificial neural network to perform classification of a preferred embodiment in accordance with the present invention, the electronic component packaging type classification system includes a service database 1, an external database 3, a feature selection database 4, a data-integration module 5, a training module 6, a parameter storage module 7 and a classification processing module 8.

The service database 1 receives electronic component patterns externally inputted and receive training data with input and output data related thereto, where the file format of the electronic component patterns is converted by the electronic design automatic (EDA) tool.

The external database 3 stores the packaging type data of a plurality of electronic components, where the classification type data record any one of the component outline information, the limited area information of printed circuit board, the drill information, the geometrical form parameter, the applicable site parameter, the electrical parameter and the joint parameter or the combination thereof.

The feature selection module 4 is connected to the external database 3; the feature selection module 4 records the packaging type features of the electronic components and inputs the electronic component patterns to be classified according to the service database 1, where the feature selection module 4 performs the feature selection from the external database 3 according to the packaging type features.

The packaging technologies for combining electronic components with circuit boards can be roughly classified into the through hole technology (THT) and the surface mount technology (SMT). Thus, the embodiment classifies the basic SMT-type electronic component packaging methods into 44 types according to pin form, pin type, size and function; the embodiment selects the most frequently used 25 types and classifies them into 10 packaging types in order to satisfy the requirements of layout engineers determining the packaging types.

During the stage, the feature selection module 4 obtains 19 features from the 25 SMT packaging types and obtains the feature values in order to provide the feature values for the data-integration module 5 to perform the data preprocessing.

More specifically, there are 19 kinds of packaging type features about the physical appearance of electronic component, the physical pin of electronic component, the electronic component pattern, etc. Moreover, the features about the physical appearance of electronic component are the pin number of electronic component, the original physical length of electronic component, the maximal physical length of electronic component, the minimal physical length of electronic component, the original physical width of electronic component, the maximal physical width of electronic component, the minimal physical width of electronic component, the physical height of electronic component, the distance between the physical body of electronic component and circuit board.

The features about the physical pin of electronic component are the pin length of large electronic component, the pin length of small electronic component, the pin width of large electronic component, and the pin width of small electronic component. The features about the electronic component pattern are the pin length of large electronic component pattern, the pin length of small electronic component pattern, the pin width of large electronic component pattern, the pin width of small electronic component pattern, the X-axis direction of pin interval of electronic component pattern, the Y-axis direction of pin interval of electronic component pattern.

In the embodiment, the weight ratio of the packaging type features is that the pattern of electronic component is higher than the physical appearance of electronic component, and the physical appearance of electronic component is higher than the physical pin of electronic component.

The data-integration module 5 performs the data pre-processing and the normalization for the feature value of the feature selected by the feature selection module 4 in order to remove incorrect noises and fill data loss and limit the feature value of the selected feature in a specific interval to obtain the training data set. More specifically, if the data processed by the data-integration module 5 are the electronic component patterns to be trained, the data are termed as the training data set for the training module to perform training; if the data processed by the data-integration module 5 are the electronic component patterns to be classified, the data are termed as the data to be classified, which are used to serve as the classification result of the packaging types.

The preprocessing is to perform data-integration, data cleaning, data loss filling and data conversion. More specifically, the object of data-integration is to solve the problems that the data are not consistent, have different units, or need to be deduplicated because the data are obtained from different databases. If the data are not consistent, the training process may not easily converge or the training result may be influenced because the columns may have different ways to present data, which may form a data set not favorable to be trained. For this reason, the data-integration is the first step in the data preprocessing.

Further, the objects of the data cleaning and the data loss filling are to ensure that the completeness, correctness and reasonableness of the data. As the data sources are diverse, the stage should check whether the features are reasonable. The features selected herein are the parameters of the electronic components, so the data loss can be filled by the overall average value.

The object of the data conversion is to convert the data into the data which can be easily trained or increase the credibility of the training result. More specifically, the tasks of the stage include data generalization, creating new attributes and data normalization. Data generalization is to enhance the concepts and meanings of the data in order to decrease the types of the feature values included in the features. Creating new attributes means finding out the new attributes needed by the training from the old attributes. Data normalization means converting the data recorded by different standards or units into the data with the same standard; the normalized data will be re-distributed over a specific and smaller interval so as to increase the accuracy of the training result. The most frequently used normalization methods include extreme value normalization, Z-score normalization and decimal normalization.

In the embodiment, the data-integration module 5 normalizes the feature value to the interval between vₐ and v_{b} to conform to the equation,

$${v}^{′} = {v}_{a} + \frac{( v - {v}_{min} ) \times ( {v}_{b} - {v}_{a} )}{{v}_{max} - {v}_{min}} , {v}_{a} < {v}_{b} ,$$

where v′ stands for the feature value after being normalized to vₐ and v_{b}, v stands for the feature value needed to be normalized, vₘₐₓ stands for the largest feature value of one feature and vₘᵢₙ stands for the smallest feature value of one feature.

The embodiment uses the normalized training data set and non-normalized training data set in the experiment for comparison. The training conditions, including the number of features, the data amount, the number of the outputted nodes and the artificial neural network (also called neural network), are as shown in Table 1:

TABLE 1

| | | Non-normalized data |
|---|---|---|
| | Normalized data set | set |
| Number of feature | 19 | 19 |
| Training data/test data | 393/50 | 393/50 |
| Normalization method | Extreme | n/a |
| | normalization | |
| Initial learning rate | 0.001 | 0.001 |
| Initial momentum | 0.8 | 0.8 |

Please refer to Table 2 and Table 3. Table 2 shows the training result of the normalized training data set; Table 3 shows the training result of the non-normalized training data set. The embodiment uses i-j-k to describe the structure of the neural network, where i stands for the neuron number of the input layer, j stands for the neuron number of the hidden layer and k stands for the neuron number of the output layer.

TABLE 2

| | Average | Average | |
|---|---|---|---|
| No (i-j-k) | RMSE | training times | Average correct rate (%) |
| 19-17-10 | 0.116678 | 3737.2 | 89.0 |
| 19-20-10 | 0.115598 | 3399.9 | 89.8 |
| 19-23-10 | 0.111255 | 4419.2 | 91.6 |
| 19-26-10 | 0.097699 | 4936.7 | 95.0 |
| 19-29-10 | 0.096829 | 5362.0 | 94.2 |
| 19-32-10 | 0.093562 | 5381.3 | 96.2 |
| 19-35-10 | 0.090389 | 5858.5 | 96.4 |
| 19-38-10 | 0.089082 | 6573.9 | 97.6 |
| 19-41-10 | 0.088672 | 6506.8 | 97.4 |
| 19-44-10 | 0.08737 | 6568.8 | 97.2 |
| 19-47-10 | 0.093352 | 7229.4 | 97.0 |
| 19-50-10 | 0.077647 | 7734.6 | 99.2 |
| 19-53-10 | 0.090195 | 7828.8 | 96.4 |
| 19-56-10 | 0.087212 | 7832.6 | 97.8 |
| 19-59-10 | 0.080051 | 8173.8 | 99.0 |
| Average | 0.094347 | 6102.9 | 95.6 |
| value | | | |

TABLE 3

| | Average | Average | |
|---|---|---|---|
| No (i-j-k) | RMSE | training times | Average correct rate (%) |
| 19-17-10 | 0.212486 | 1360.6 | 41.4 |
| 19-20-10 | 0.287439 | 2840.4 | 28.8 |
| 19-23-10 | 0.233103 | 2203.3 | 34.8 |
| 19-26-10 | 0.282624 | 3851.8 | 30.8 |
| 19-29-10 | 0.202941 | 1080.5 | 41.6 |
| 19-32-10 | 0.231433 | 2654.5 | 44.00 |
| 19-35-10 | 0.262298 | 3344.4 | 34.6 |
| 19-38-10 | 0.232789 | 2754.5 | 37.00 |
| 19-41-10 | 0.226421 | 2223.2 | 40.4 |
| 19-44-10 | 0.204041 | 1676.9 | 46.2 |
| 19-47-10 | 0.234809 | 2264.8 | 38.4 |
| 19-50-10 | 0.178190 | 2356.4 | 46.2 |
| 19-53-10 | 0.156297 | 3151.2 | 51.8 |
| 19-56-10 | 0.194641 | 1802.1 | 40.2 |
| 19-59-10 | 0.200062 | 2756.1 | 38.6 |
| Average | 0.222638 | 2421.4 | 39.7 |
| value | | | |

According to the results shown in Table 2 and Table 3, the average correct rate of the normalized data set, No. (19-50-10), is 99.2% and the average correct rate of the non-normalized data set, No. (19-53-10), is 51.8%. Therefore, the performance of the classification result of the normalized data set is better than that of the classification result of the non-normalized data set by 55.9%.

In addition, the distance between the feature values of all features can decrease after the normalization of the data set; accordingly, the artificial neural network can more easily calculate the weight of the connection between the neurons. If the data fail to be normalized, the weight may exceed the interval of the activation function and cannot be correctly adjusted, so the artificial neural network will converge too soon and fail to achieve the training and learning effects.

The present invention makes the features re-distribute over a specific interval via extreme value normalization in order to better the efficiency of training the artificial neural network. Besides, the correct rate of the normalized training result is higher than that of the non-normalized training result.

The training module 6 integrates the feed-forward neural network (FNN) structure with the backpropagation algorithm; the backpropagation algorithm belongs to the multi-layer feed-forward neural network and divides the neural network into the input layer, the hidden layer and the output layer. The input layer serves as the terminal for receiving data and inputting messages in the network structure; the neuron number of the input layer means the number of the training features included therein, which stands for the variables inputted into the network.

The hidden layer is between the input layer and the output layer, which is used to show the situation of the mutual influence between the units. The trail-and-error method is the best way to find out the neuron number of the hidden layer. The more the neuron number is, the lower the convergence speed and the error will be. The output layer serves as the terminal for processing training results and outputting messages in the network structure, which stands for the variables outputted from the network.

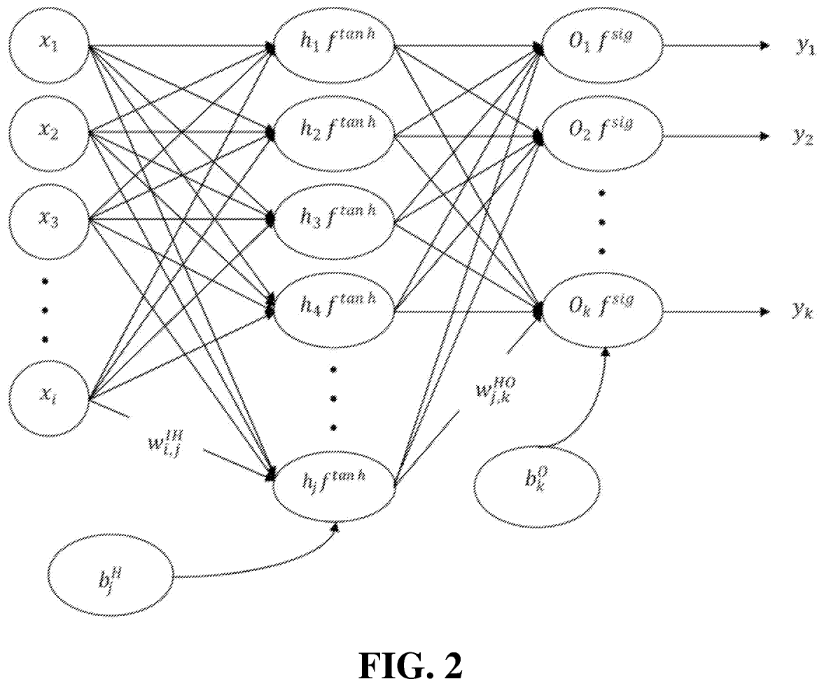

The backpropagation algorithm is used to minimize the error and find out the weights of the connections between the input layer, the hidden layer and the output layer, as shown in FIG. 2; the backpropagation artificial neural structure can be divided into 3 parts, including the input, the weight and the activation function. The weight can be further divided into the weight and the bias. More specifically, x₁, x₂, x₃ . . . xᵢ stand for the input signals; w_{1,1}^{IH}, w_{1,2}^{IH}, w_{1,3}^{IH} . . . w_{i,j}^{IH} stand for the weights of the connections between the neurons of the input layer and the neurons of the hidden layer; bⱼ^{H} stand for the biases of the neurons of the hidden layer; h₁ h₂ h₃ . . . hⱼ stand for the sum of the product of the input items xₙ and the weights w_{i,j}^{IH}, as shown in the equation, hⱼ(X)=Σᵢ₌₁^{N}(xᵢ·w_{i,j}^{IH})+bⱼ^{H}.

Afterward, hⱼ is substituted into the activation function ƒ^{tanh} to generate the output of the hidden layer, which also serves as the input of the next layer. So as to simulate the operation mode of the biological neural network, the activation function is usually a non-linear conversion; the conventional activation functions are the hyper tangent function and the sigmoid function [28], as shown in the following equations:

$${f}^{tanh} ( {h}_{j} ) = \frac{{e}^{{h}_{j}} - {e}^{- {h}_{j}}}{{e}^{{h}_{j}} + {e}^{- {h}_{j}}}$$

$${f}^{sig} ( {O}_{k} ) = \frac{1}{1 + {e}^{- {O}_{k}}}$$

$${O}_{k} ( H ) = {\sum }_{j = 1}^{M} ( {f}^{tanh} ( {h}_{i} ) \cdot {w}_{j , k}^{HO} ) + {b}_{k}^{O}$$

The activation function used by the hidden layer is the hyper tangent function; the output uses the sigmoid function. w_{1,1}^{HO}, w_{1,2}^{HO}, w_{1,3}^{HO} . . . w_{j,k}^{HO} stand for the weights of the connections between the neurons of the hidden layer and the neurons of the output layer; bₖ^{O} stands for the biases of the neurons of the output layer; O₁, O₂, . . . , Oₖ stand for the sum of the product of the input items ƒ^{tanh}(hⱼ) and the weights w_{j,k}^{HO}. Finally, Oₖ is substituted into the activation function ƒ^{sig}(Oₖ) to generate the outputs yₖ of the neurons, as shown in the equation, yₖ(O)=ƒ^{sig}(Oₖ).

When failing to reach the convergence condition, the backpropagation neural network will calculate the error between the output result and the target result, then re-adjust the weight and re-start the training until the convergence condition is reached, as shown in the equation, wₜ=(wₜ₋₁+Δw).

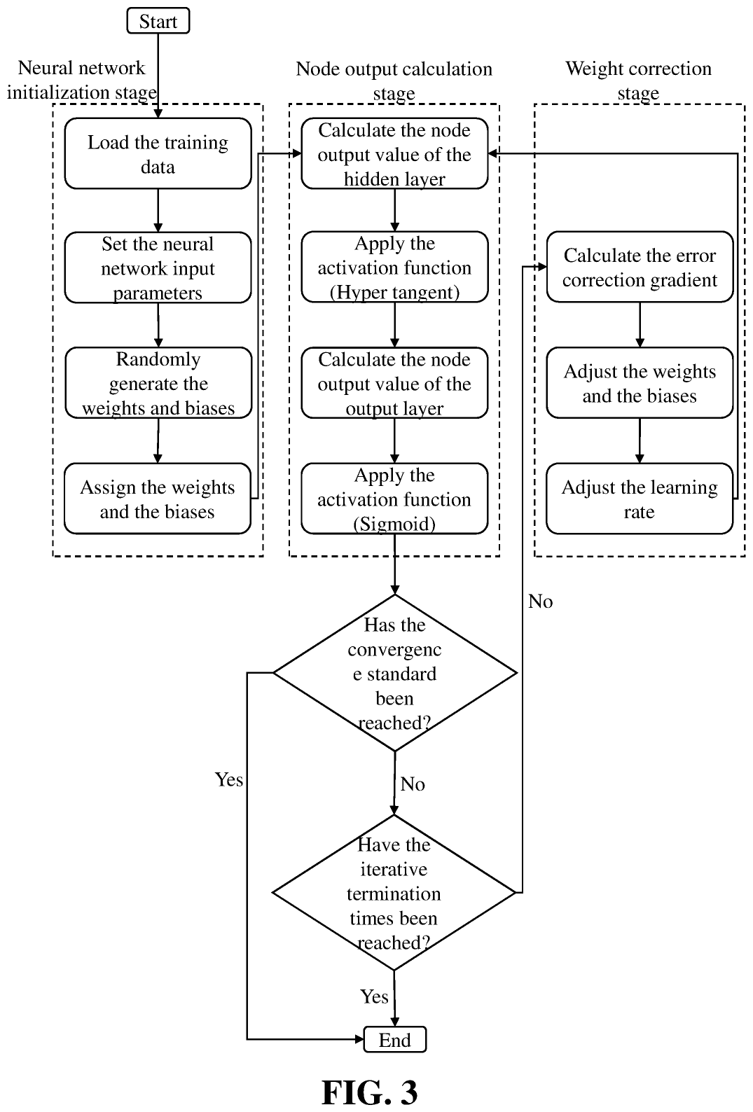

The training module 6 is connected to the data-integration module 5 and the service database 1, and determines the training scale of training the training data set and the neural network parameters to serve as the bases of the following classification; then, the training result is transmitted to the service database 1, where the convergence condition is that the cumulative error is lower than the given threshold value after the current training ends. Please refer to FIG. 3; the embodiment divides the training process into the neural network initialization stage, the node output calculation stage and the weight correction stage, where the aforementioned nodes are also called neurons. First, the training process trains the training data (also called training data set), sets the network input parameters, randomly generates the weights and the biases, assigns the weights and the biases during the neural network initialization stage. Then, the training process proceeds to the node output calculation stage; the neural network initialization stage calculates the node output values of the hidden layer, applies the activation function (Hyper tangent) of the hidden layer, calculates the node output values of the output layer and applies the activation function (Sigmoid) of the nodes of the output layer during the node output calculation stage. Finally, the training process calculates the error correction gradient and adjusts the weights, the biases and the learning rate to achieve the output result conforming to the convergence standard during the weight correction stage, and then the training process ends. If the convergence standard fails to be reached, the training process determines whether it has reached the iterative termination times, and then implements the weight correction stage and the node output calculation stage until the output result achieves the convergence standard; then, the training process ends.

Moreover, when executing the neural network initialization stage, the system asks for that the neural network parameters should be inputted, and the weights and the biases should be initialized first. The three neural network parameters set in the stage are the initial learning rate, the initial momentum and the node number of the hidden layer.

Initial learning rate: when the initialization is implemented, the learning rate will be set within the interval [0,1]. The embodiment uses the self-adaptive learning rate adjustment method, which will determine whether the training direction is correct according to the cumulative error of the training of each time. If the error tends to decrease, it means the training direction is correct; in this way, the learning speed can increase. On the contrary, if the error tends to increase, the penalty factors will be added to reduce the learning speed and decrease the learning progress; then, the training direction should be modified.

Initial momentum: in addition to the setting of the learning rate, the value of the momentum will also influence the learning efficiency of the neural network. The major function of the momentum is to stabilize the oscillation phenomenon caused by calculating the weights after the learning rate is adjusted. During the initialization process, the parameters can be set within the interval [0,1], just like the learning rate. The system will automatically add the parameters for adjustment when adjusting the learning rate and the weights each time.

Node number of the hidden layer: the node number of the hidden layer will influence the convergence speed, the learning efficiency and the training result. The embodiment adopts the trail-and-error method.

The convergence condition can be set be that the training stops after the maximal training times are reached or the cumulate error is lower than a given threshold value. More specifically, the maximal training times mean that the training stops after the training times reach the predetermined maximum, which shows the training cannot make the neural network exactly converge; thus, it is necessary to adjust the neural network parameters or check whether the training data set is abnormal. If one of the above conditions is reached, the training ends.

In the embodiment, the convergence condition of the training is that the training stops when the cumulative error is lower than 1/15000 of the previous training after the current training ends. vₜ^{rmse} stands for the RMSE accumulated by the current training; vₜ₋₁^{rmse} stands for the RMSE accumulated by the previous training, which conform to the equation:

$$( {v}_{t}^{rmse} - {v}_{t - 1}^{rmse} ) < \frac{{v}_{t - 1}^{rmse}}{15000} . {v}_{t}^{rmse} and {v}_{t - 1}^{rmse}$$

conform to the equation:

$${v}^{rmse} = \frac{{\sum }_{i = 0}^{{c}_{d}} \sqrt{\frac{{\sum }_{j = 0}^{{c}_{o}} {( {v}_{k}^{c} - {v}_{k ( t )}^{a} )}^{2}}{{c}_{o}}}}{{c}_{d}} ,$$

where v^{rmse} stands for the RMSE accumulated by the training result each time; c_{d} stands for the data volume of the training data set; cₒ stands for the number of the bits outputted by the neural network; vₖ^{c} stands for the target value of the classification result; vₖ₍ₜ₎^{a} is the approximate value of the current classification result.

Furthermore, the neural network parameters are any one of the convergence condition, the neuron number of the hidden layer, the number of the hidden layers, the initial learning rate, the initial momentum, the threshold value, the weight and the bias or the combination thereof.

Please refer to FIG. 2; when executing the node output calculation stage, the system gradually calculates the output value of each input node, adds the bias to the calculated output value and then processes which by the activation function in order to serve as the input value of the next layer.

The embodiment uses i-j-k to describe the neural network structure, where i stands for the neuron number; j stands for the neuron number of the hidden layer; k stands for the neuron number of the output layer. x₁˜xᵢ stand for the inputted feature value; hⱼ is calculated according to the weights w_{i,j}^{IH} of the connections between the input layer and the hidden layer by using the equation, hⱼ(X)=Σᵢ₌₁^{N}(xᵢ·w_{i,j}^{IH})+bⱼ^{H}. Then, the value of hⱼ processed by the activation function ƒ^{tanh} is used as the input value of the connection between the hidden layer and the input layer, and which is multiplied by the weights w_{j,k}^{HO} of the connections between the hidden layer and the output layer; afterward, Oₖ can be obtained by the equation, Oₖ(H)=Σⱼ₌₁^{M}(ƒ^{tanh}(hᵢ)·w_{j,k}^{HO})+bₖ^{O}. Finally, the classification result yₖ of each piece of data can be obtained via the activation function by using the equation, yₖ(O)=ƒ^{sig} (Oₖ).

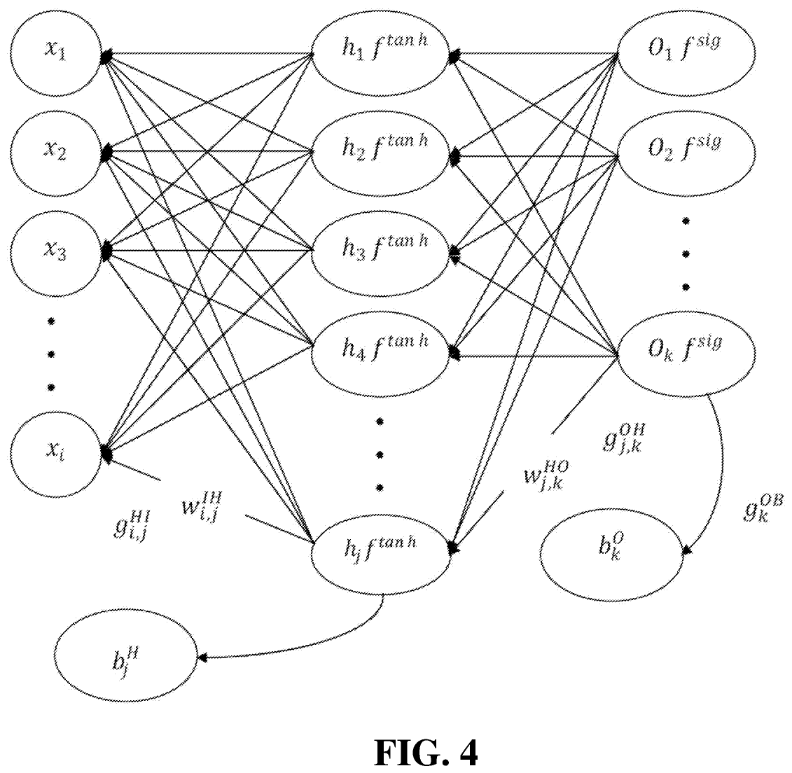

Please refer to FIG. 4, during the weight modification stage, the system adjusts the weights, the biases and the learning rate according to the cumulative error of the previous training. Via the adjustment of the three variables, the training module 6 can have better learning ability. In addition, the training conditions can also be slightly modified according to the training result each time in order to make sure that the learning direction is correct, and the learning performance can be best.

The way of adjusting the weight is to make the calculation from the output layer to the input layer in order to calculate the four gradients respectively, including the bias gradient of the output layer, the weight gradient from the hidden layer to the output layer, the bias gradient of the hidden layer and the weight gradient from the hidden layer to the output layer; then, the variation can be calculated according to the gradients. Finally, the weights should be modified according to the variation and the momentum.

When adjusting the weights, the first step is to calculate the bias gradient gₖ^{OB} of the output layer, the gradient g_{k,j}^{OH} from each of the nodes between the output layer and the hidden layer, the bias gradient gₖ^{HB} of the hidden layer and the gradient g_{j,i}^{HI} of each of the nodes between the hidden layer and the input layer. vₖ^{c} stands for the target value of the k^{th} output and vₖ₍ₜ₎^{a} stands for the approximate value of the k^{th} output, which conform to the equations gₖ^{OB}=(vₖ^{c}−vₖ₍ₜ₎^{a}), g_{k,j}^{OH}=Σⱼ₌₁^{M}(gₖ^{OB}·w_{j,k}^{HO}), gₖ^{HB}=(vₖ^{c}−vₖ₍ₜ₎^{a} and g_{j,i}^{HI}=Σᵢ₌₁^{N}(gⱼ^{HB}·w_{i,j}^{IH}).

The next step is to calculate the variation Δbₖ^{O} of the bias of the output layer, the variation Δw_{j,k}^{HO} of the weight from the output layer to the hidden layer, the variation Δbⱼ^{H} of the bias of the hidden layer and the variation Δw_{i,j}^{IH} of the weight from the input layer to the hidden layer. During the calculation process, the variations are multiplied by the learning rate η to more obviously adjust the variations, which conforms to the equations, Δbₖ^{O}=gₖ^{OB}×η, Δw_{j,k}^{HO}=g_{j,k}^{HO}×η, Δbⱼ^{H}=gⱼ^{HB}×η and Δw_{i,j}^{IH}=g_{i,j}^{IH}×η.

Finally, the variations of the gradients and the weights can be used to update the weights w_{i,j(t)}^{IH} of the connections between the input layer and the hidden layer, the bias bⱼ₍ₜ₎^{H} of the hidden layer, the weights w_{j,k(t)}^{HO} of the connections between the hidden layer and the output layer and the bias bⱼ₍ₜ₎^{O} of the output layer, and the which are multiplied by the momentum in order to reduce the oscillation during the training process due to the adjustment of the weights and serve as the parameters of the next training. The above process conforms to the equations, w_{i,j(t)}^{IH}=(w_{i,j(t-1)}^{IH}+Δw_{i,j}^{IH})×M^{mom}, bⱼ₍ₜ₎^{H}=(bⱼ₍ₜ₋₁₎^{H}+Δbⱼ^{H})×M^{mom}, w_{j,k(t)}^{HO}=(w_{j,k(t-1)}^{HO}+Δw_{j,k}^{HO})×M^{mom} and bₖ₍ₜ₎^{O}=(bₖ₍ₜ₋₁₎^{O}+Δbₖ^{O})×M^{mom}.

The stage adopts the self-adaptive learning rate to serve as the factor of calculating the variation of the weight. The adjustment of the learning rate will compare the previous training result vₜ₋₁^{rmse} with the current training result vₜ^{rmse} in order to determine whether the learning direction is correct. If the learning direction is correct, the learning rate will be added with the incentive factors to make the next training faster; thus, the learning process can be more early reach the convergence condition. On the contrary, if the learning direction is incorrect, the learning rate will be added with the penalty factors to slow down the learning speed so as to maintain the learning effect. The equation is as follows:

$${η}_{( t )} = \{ \begin{matrix}{η}_{( t - 1 )} \times ( 1 + \vert {v}_{t}^{rmse} - {v}_{t - 1}^{rmse} \vert ) , & {v}_{t}^{rmse} < {v}_{t - 1}^{rmse} \\ {η}_{( t - 1 )} , & {v}_{t - 1}^{rmse} < {v}_{t}^{rmse} < 1.05 \times {v}_{t - 1}^{rmse} \\ {η}_{( t - 1 )} \times ( 1 - \vert {v}_{t}^{rmse} - {v}_{t - 1}^{rmse} \vert ) , & 1.05 \times {v}_{t - 1}^{rmse} < {v}_{t}^{rmse}\end{matrix} \qquad$$

The RMSE obtained by the training process each time can be used to adjust the weights and the learning rate to make the training process move in the correct direction in order to avoid that the training process fails to converge during the training process.

In the embodiment, the training scale includes a training layer, a hidden layer and an output layer. More specifically, the input layer is the number of the features of the inputted packaging types; the number of the hidden layer is 1 and the output layer is the number of the packaging types of the classification output, where the number of the features of the input layer is 19 and the number of the packaging types of the classification output is 10.

The neuron number j of the hidden layer conforms to (x×(input+output)), 1.5<x<2, wherein input is 19 features of inputted packaging types and output is 10 packaging types of the classification output. Preferably, when the neuron number of the hidden layer is close to the above equation, the better training and the training classification result can be obtained.

More specifically, the packaging types outputted are the ball grid array (BGA), the quad flat package (QFP), the quad flat no-lead (QFN), the small outline integrated transistor (SOT), the small outline integrated circuit (SOIC), the small outline integrated circuit no-lead (SON), the dual flat no-lead (DFN), the small outline diode (SOD), the small SMC chip and the metal electrode leadless face (MELF).

The parameter storage module 7 is connected to the training module 6 and the service database 1; the parameter storage module 7 is used to record the training parameter data used by the training module 6.

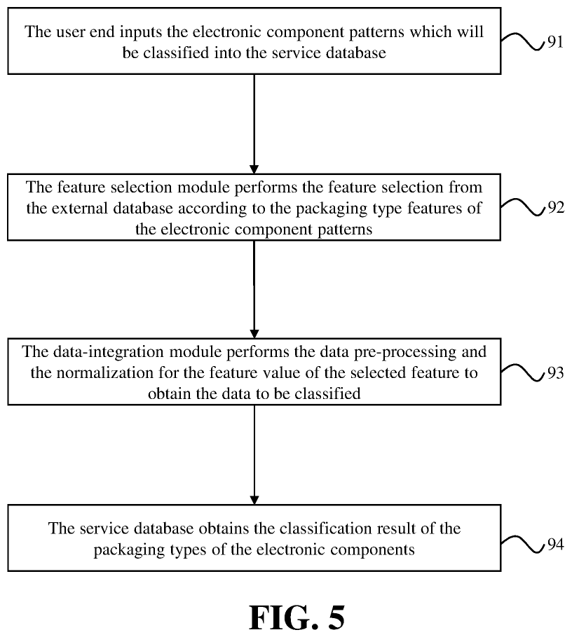

Please refer to FIG. 5; the classification processing module 8 receives the data to be classified and shows the classification result on the service database 1. When implementing the system, the classification processing module 8 can be independently disposed at the user end or disposed inside the same electronic device so as to perform the training and the classification of the electronic component packaging types; however, which is just an example instead of limitation. The classification result may be the data to be classified or the result of processing the data to be classified.

The classification processing module 8 includes a processor storing and executing the instruction of an operation, and the operation includes the following steps.

The first step is Step 91: a user end inputs the electronic component patterns to be classified into the service database 1; then, the second step is Step 92: the feature selection module 4 performs the feature selection from the external database 3 according to the packaging type features of the electronic component patterns.

Afterward, the third step is Step 93: the data-integration module 5 performs the data pre-processing and the normalization for the feature value of the selected feature to obtain the data to be classified.

The Final step is Step 94: the service database 1 obtains the classification result of the packaging types of the electronic components.

The present invention uses the feature training neural network of 19 physical electronic components to find out the training scale and the neural network parameters most suitable for the classification system. Moreover, the correct rate of the normalized training result is higher than that of the non-normalized training result. Furthermore, when the neuron number of the hidden layer satisfies (x×(input+output)), 1.5<x<2, the system can obtain better training result and better classification result of the training.

To sum up, the present invention applies the artificial neural network to the electronic component packaging classification system. Via the cooperation relations between the service database 1, the external database 3, the feature selection module 4, the data-integration module 5, the training module 6, the parameter storage module 7 and the classification processing module 8, and the integration of the backpropagation artificial neural network, the present invention can solve the problems that manually classifying the packaging types of the electronic components tends to result in mistakes, is time-consuming and seriously depends on the working experience of layout engineers, and can further better the quality of the training and the classification result, which can definitely achieve the objects of the present invention.

The above disclosure is related to the detailed technical contents and inventive features thereof. Those skilled in the art may proceed with a variety of modifications and replacements based on the disclosures and suggestions of the invention as described without departing from the features thereof. Nevertheless, although such modifications and replacements are not fully disclosed in the above descriptions, they have substantially been covered in the following claims as appended.

What is claimed is:

1. An electronic component packaging type classification system using artificial neural network, comprising:
a service database, configured to receive electronic component patterns externally inputted, and receive training data with input and output data related thereto;
an external database, configured to store packaging type data of a plurality of electronic components;
a feature selection module, connected to the external database, and configured to record packaging type features of the electronic components and input the electronic component patterns to be classified according to the service database, wherein the feature selection module performs a feature selection from the external database according to the packaging type features;
a data-integration module, configured to perform a data pre-processing and a normalization for a feature value of a feature selected by the feature selection module in order to remove incorrect noises and fill data loss, and limit the feature value of the selected feature in a specific interval to obtain data to be classified; and
a classification processing module, configured to receive the data to be classified and display a classification result on the service database.

2. The electronic component packaging type classification system of claim 1, wherein the classification processing module comprises a processor storing and executing an instruction of an operation, and the operation comprises:
a user end inputting the electronic component patterns to be classified into the service database;
the feature selection module performing the feature selection from the external database according to the packaging type features of the electronic component patterns;
the data-integration module performing the data pre-processing and the normalization for the feature value of the selected feature to obtain the data to be classified; and
the service database obtaining the classification result of the packaging types of the electronic components.

3. The electronic component packaging type classification system of claim 2, further comprising a training module and a parameter storage module, wherein the training module is connected to the data-integration module and the service database, and determines a training scale and neural network parameters of a training data set for preparing following classification, wherein a convergence condition of training is that a cumulative error is lower than a given threshold value after a current training ends; the parameter storage module is connected to the training module and the service database, and configured to record training parameter data used by the training module.

4. The electronic component packaging type classification system of claim 3, wherein the data-integration module normalizes the feature value to an interval between vₐ and v_{b} to conform to the equation,
$${v}^{′} = {v}_{a} + \frac{( v - {v}_{min} ) \times ( {v}_{b} - {v}_{a} )}{{v}_{max} - {v}_{min}} , {v}_{a} < {v}_{b} ,$$
wherein v′ stands for a feature value after being normalized vₐ and v_{b}, v′ stands for a feature value needed to be normalized, vₘₐₓ stands for a largest feature value of one feature and vₘᵢₙ stands for a smallest feature value of one feature.

5. The electronic component packaging type classification system of claim 4, wherein the neural network parameters are any one of the convergence condition, a neuron number of a hidden layer, a number of the hidden layers, an initial learning rate, an initial momentum, a threshold value, a weight and a bias or a combination thereof.

6. The electronic component packaging type classification system of claim 5, wherein the neuron number of the hidden layer conforms to the equation, (x×(input+output)), 0.5<x<2, wherein the input stands for 19 packaging type features and the output stands for the 10 packaging types of classification output.

7. The electronic component packaging type classification system of claim 6, wherein the classification type data record any one of a component outline information, a limited area information of printed circuit board, a drilling information, a geometrical form parameter, an applicable site parameter, an electrical parameter and a joint parameter or a combination thereof.

8. The electronic component packaging type classification system of claim 7, wherein the packaging type features comprise a physical appearance of electronic component, a physical pin of electronic component and a pattern of electronic component.

9. The electronic component packaging type classification system of claim 8, wherein a weight ratio of the packaging type features is that the pattern of electronic component is higher than the physical appearance of electronic component and the physical appearance of electronic component is higher than the physical pin of electronic component.

10. The electronic component packaging type classification system of claim 9, wherein the physical appearance of electronic component, the physical pin of electronic component and the pattern of electronic component are selected from the group consisting of 19 kinds of features, a pin number of electronic component, an original physical length of electronic component, a maximal physical length of electronic component, a minimal physical length of electronic component, an original physical width of electronic component, a maximal physical width of electronic component, a minimal physical width of electronic component, a physical height of electronic component, a distance between physical body of electronic component and circuit board, a pin length of large electronic component, a pin width of small electronic component, a pin length of large electronic component pattern, a pin length of small electronic component pattern, a pin width of large electronic component pattern, a pin width of small electronic component pattern, a X-axis direction of pin interval of electronic component pattern and a Y-axis direction of pin interval of electronic component pattern.
